(19) United States
(12) Patent Application Publication
(10) Pub. No.: US 2023/0167257 A1
(43) Pub. Date: Jun. 1, 2023

(54) ARTICLE AND METHOD OF MAKING

(71) Applicant: SAINT-GOBAIN PERFORMANCE PLASTICS CORPORATION, Solon, OH (US)

(72) Inventors: Morgane A. S. LAURENT, Clinton, MA (US); Jinsheng WU, Lexington, MA (US); Xipeng LIU, Concord, MA (US); Adam P. NADEAU, Boylston, MA (US)

(21) Appl. No.: 18/060,356

(22) Filed: Nov. 30, 2022

Related U.S. Application Data
(60) Provisional application No. 63/284,422, filed on Nov. 30, 2021.

(51) Int. Cl. B29C 71/02

(52) U.S. Cl. CPC C08J 7/08; C08J 2383/04

(57) ABSTRACT

An article including at least one polymer, the at least one polymer including a silicone elastomer, a thermoplastic elastomer, or combination thereof, wherein the article has an outer surface treated to provide at least silicon moieties, silicon-oxide moieties, silica-like moieties, organosilicon moieties, hydroxyl moieties, hydrocarbon moieties, or combination thereof, wherein the outer surface has a tack decrease of at least 50% compared to a non-treated outer surface.

### CROSS-REFERENCE TO RELATED APPLICATION(S)

This application claims priority under 35 U.S.C. § 119(e) to U.S. Provisional Patent Application No. 63/284,422, entitled “AN ARTICLE AND METHOD OF MAKING,” filed Nov. 30, 2021, by Morgane A.S. LAURENT et al., which is assigned to the current assignee hereof and is incorporated herein by reference in its entirety.

### FIELD OF THE DISCLOSURE

This disclosure, in general, relates to an article and method for making the article.

### BACKGROUND

Silicone-based materials are widely used for their properties desired in medical, pharmaceutical, food, and biological industries. For instance, silicone-based materials typically are non-toxic, flexible, thermally stable, have low chemical reactivity, and can be produced in a variety of sizes. With silicone products, challenges remain to prevent dust accumulation on their surface, particularly when sterility is desired. Furthermore, reduction of the tackiness of the surface of the silicone product is desirable, for instance, for handling and when in contact with an external surface. Accordingly, it would be advantageous to modify the surface of a silicone product.

Previous surface treatments have had their challenges due to the ability of a silicone elastomer to recover. For instance, plasma treatment does not maintain stability of the surface for a workable period of time. As such, the surface of the silicone only remains modified for a short period of time before the silicone elastomer recovers and the surface returns to its original surface properties.

Accordingly, an improved article with a modified, stable surface is desired.

### SUMMARY

In an embodiment, an article includes at least one polymer, the at least one polymer including a silicone elastomer, a thermoplastic elastomer, or combination thereof, wherein the article has a surface treated to provide at least silicon moieties, silicon-oxide moieties, silica-like moieties, organosilicon moieties, hydroxyl moieties, hydrocarbon moieties, or combination thereof to the surface, wherein the treated surface has a tack decrease of at least 50% compared to a non-treated surface.

In an embodiment, a method of treating an article includes: providing an article including at least one polymer, the at least one polymer including a silicone elastomer, a thermoplastic elastomer, or combination thereof; and surface treating a surface of the at least one polymer to add at least silicon moieties, silicon-oxide moieties, silica-like moieties, organosilicon moieties, hydroxyl moieties, hydrocarbon moieties, or combination thereof to the surface, wherein the treated surface has a tack decrease of at least 50% compared to a non-treated outer surface.

In yet another embodiment, a method of treating an article includes: providing an article including at least one polymer, the at least one polymer including a silicone elastomer; and surface treating a surface of the at least one polymer to reduce the tack of the surface, wherein the surface treatment includes plasma enhanced chemical vapor deposition, flame treatment, or combination thereof.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary tube.

The use of the same reference symbols in different drawings indicates similar or identical items.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are open-ended terms and should be interpreted to mean “including, but not limited to . . . ” These terms encompass the more restrictive terms “consisting essentially of” and “consisting of” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 25° C. For instance, values for viscosity are at 25° C., unless indicated otherwise.

In a particular embodiment, an article includes at least one polymer. In an embodiment, the polymer includes a silicone elastomer, a thermoplastic elastomer, or combination thereof. The polymer has a surface that is treated to modify the surface. In an embodiment, a surface treatment provides moieties to the surface to provide advantageous properties to the article. In an embodiment, the surface treatment generates at least silicon moieties, silicon-oxide moieties, silica-like moieties, organosilicon moieties, hydroxyl moieties, hydrocarbon moieties, or combination thereof to the surface of the article. “Silica-like” as used herein refers to silicon-oxygen-carbon-hydrogen containing moieties. The surface treatment may decrease tack, decrease dust pick-up, or combination thereof compared to a surface that is not surface treated.

The surface treatment of the surface of the article includes any method that decreases the tack and/or dust pick-up of the treated surface compared to an untreated surface. Any surface treatment is envisioned and includes, for example, plasma enhanced chemical vapor deposition, flame treatment, plasma activation, chemical vapor deposition, or combination thereof. In an embodiment, the surface treatment includes plasma enhanced chemical vapor deposition in the presence of any reasonable compound that forms moieties that advantageously reduce tack and/or reduce dust pick-up on the surface. For instance, the compound is selected that provides silicon moieties, silicon-oxide moieties, silica-like moieties, organosilicon moieties, hydroxyl moieties, hydrocarbon moieties, or combination thereof on the surface of the article. In an embodiment, the plasma enhanced chemical vapor deposition is in the presence of a siloxane compound, a silane compound, or combination thereof such as, for example, an alkoxysilane, cyclic silane, or combination thereof. In a more particular embodiment, the siloxane compound includes, for example, hexamethyldisiloxane (HMDSO), tetraethyl orthosilicate (TEOS), tetramethylcyclotetrasiloxane (TMCTS), octamethylcyclotetrasiloxane (OMCTS), or combination thereof.

In an embodiment, the surface treatment is a flame treatment. Any flame treatment is envisioned and any conditions are envisioned that advantageously reduce tack and/or reduce dust pick-up on the surface. For instance, the flame treatment is in the presence of a gas. In an embodiment, the gas is an alkane gas. Exemplary alkane gases include methane, propane, butane, coal gas, or combination thereof. Further conditions include a flame temperature and time with the proviso that the flame temperature and time is such as to provide advantageous surface properties without degradation of a bulk of the polymer. Any reasonable flame temperature and any reasonable time are envisioned. For instance, the flame temperature is between 800° C. and 2000° C., such as between 950° C. and 1200° C., or between 1300° C. and 1800° C., or even no greater than 2200° C. Any time is envisioned such as not greater than 30 seconds, such as 0.5 seconds to 30 seconds. It will be appreciated that the temperature and time can be within a range between any of the minimum and maximum values noted above. In an embodiment, the moiety formed on the surface from the flame treatment are dependent on the gas and include, for example, the silicon moieties, silicon-oxide moieties, silica-like moieties, organosilicon moieties, hydroxyl moieties, hydrocarbon moieties, or combination thereof.

The use of the surface treatment provides a modified surface. As stated, the moieties are formed through surface treatment, thus providing a stable treated surface that has decreased tack and/or decreased dust pick-up. “Stable treated surface” as used herein refers a treated surface that maintains its treated properties for at least 30 days, such as at least 90 days, or even greater than 6 months.

In an embodiment, the article with the treated surface includes a polymer. Any reasonable polymer is envisioned and includes any reasonable thermoplastic polymer and any reasonable thermoset polymer. In an embodiment, the polymer includes a thermoplastic elastomer such as a polyurethane, a polyolefin, a polyvinyl chloride, a styrene-based elastomer, a synthetic rubber, a blend, the like, or combination thereof. In a particular embodiment, the polymer includes a silicone elastomer. In an embodiment, the silicone elastomer is a high consistency rubber (HCR), a liquid silicone rubber (LSR), a room temperature vulcanizing silicone (RTV), or a combination thereof. In a particular embodiment, the silicone elastomer is a liquid silicone rubber. The liquid silicone rubber typically has a viscosity prior to cure of about 50,000 centipoise (cPs) to about 2,000,000 cPs, such as about 200,000 cPs to about 1,000,000 cPs, such as about 500,000 cPs to about 800,000 cPs. In an alternative embodiment, the silicone elastomer is a high consistency rubber. Prior to cure, the high consistency rubber typically has a viscosity of greater than about 2,000,000 centipoises, such as about 2,000,000 cps to about 500,000,000 cps. It will be appreciated that the viscosity of the silicone elastomer can be within a range between any of the minimum and maximum values noted above.

The silicone elastomer may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polyalkylsiloxane, such as a silicone hydride-containing polydimethylsiloxane. In a further embodiment, the polyalkylsiloxane is a vinyl-containing polyalkylsiloxane, such as a vinyl-containing polydimethylsiloxane. In yet another embodiment, the silicone polymer is a combination of a hydride-containing polyalkylsiloxane and a vinyl-containing polyalkylsiloxane, such as a combination of hydride-containing polydimethylsiloxane and a vinyl-containing polydimethylsiloxane. In an example, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone.

The silicone elastomer may further include a catalyst. Typically, the catalyst is present to initiate the crosslinking process. Any catalyst is envisioned depending upon the silicone formulation. In an embodiment, a hydrosilylation reaction catalyst may be used. For instance, an exemplary hydrosilylation catalyst is an organometallic complex compound of a transition metal. In an embodiment, the catalyst includes platinum, rhodium, ruthenium, the like, or combinations thereof. In a particular embodiment, the catalyst includes platinum. Further optional catalysts may be used with the hydrosilylation catalyst. Exemplary optional catalysts may include peroxide, tin, or combinations thereof. Alternatively, the silicone elastomer further includes a peroxide catalyzed silicone formulation. In another example, the silicone elastomer may be a combination of a platinum catalyzed and peroxide catalyzed silicone formulation.

The silicone elastomer may further include an additive. Any reasonable additive is envisioned. Exemplary additives may include, individually or in combination, a vinyl polymer, a methyl polymer, a hydride, an adhesion promoter, a filler, an initiator, an inhibitor, a colorant, a pigment, a carrier material, an anti-microbial, or any combination thereof. For instance, the additive may include an adhesion promoter such as a silane, such as 3-methacryloxypropyltrimethoxysilane, 3-glycidoxypropyltrimethoxysilane, vinyl-tris(2-methoxyethoxy)-silane; 2,5,7,10-tetraoxa-6-silaundecane, 6-ethenyl-6-(2-methoxyethoxy)-silane, or any combination thereof. In an embodiment, the material content of the article is essentially 100% silicone elastomer. In some embodiments, the silicone elastomer consists essentially of the respective silicone polymer described above. As used herein, the phrase “consists essentially of” used in connection with the silicone elastomer precludes the presence of non-silicone polymers that affect the basic and novel characteristics of the silicone elastomer, although, commonly used processing agents and additives may be used in the silicone elastomer.

The silicone elastomer may include a conventional, commercially prepared silicone formulation. The commercially prepared silicone elastomer typically includes components such as the silicone polymer, the catalyst, a filler, and optional additives. Any reasonable filler and additives are envisioned. Particular embodiments of a commercially available liquid silicone rubber (LSR) include Wacker Elastosil® LR 3003/50 by Wacker Silicone of Adrian, Mich. and Rhodia Silbione® LSR 4340 by Rhodia Silicones of Ventura, Calif.

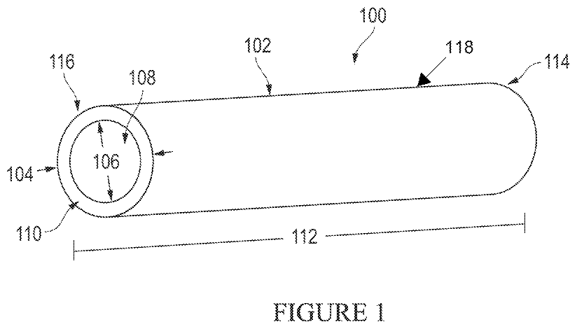

FIG. 1 is a view of an exemplary article, such as a tube 100 according to an embodiment. In a particular embodiment, the tube 100 can include a body 102 having an outside diameter 104 and an inner diameter 106. The inner diameter 106 can form a hollow bore 108 of the body 102. The hollow bore 108 defines a central lumen of the tube. In addition, the body 102 is illustrated as a single layer, the single layer including the polymer such as the silicone elastomer, the thermoplastic elastomer, or combination thereof. The layer can include a thickness 110 that is measured by the difference between the outside diameter 104 and the inner diameter 106.

In a particular embodiment, the outside diameter 104 of the body 102 is about 0.25 inches to about 5.0 inches, such as about 0.5 inches to about 2.0 inches. It will be appreciated that the outside diameter 104 can be within a range between any of the minimum and maximum values noted above. In an embodiment, the inner diameter 106 of the body 102 is about 0.005 inches to about 4.0 inches, such as about 0.03 inches to about 4.0 inches, such as about 0.06 inches to about 1.0 inches. It will be appreciated that the inner diameter 106 can be within a range between any of the minimum and maximum values noted above.

Further, the body 102 can have a length 112, which is a distance between a distal end 114 and a proximal end 116 of the tube 100. In a further embodiment, the length 112 of the body 102 can be at least about 2 meters, such as at least about 5 meters, such as at least about 10 meters. The length 112 is generally limited by pragmatic concerns, such as storing and transporting long lengths, or by customer demand.

Further, the body 102 has a surface 118. The surface 118 can be an outer surface of the tube 100. Surface treatment includes a modification to the surface 118 of the polymer leading to decreased tack and/or dust pick-up. Surface treatment includes plasma enhanced chemical vapor deposition, flame treatment, plasma activation, chemical vapor deposition, or combination thereof. In an embodiment, modification of the surface 118 can be via creating moieties such as silicon moieties, silicon-oxide moieties, silica-like moieties, organosilicon moieties, hydroxyl moieties, hydrocarbon moieties, or combination thereof. The moieties are present as a coating (not illustrated), or from the surface 118 through the thickness 110 of the article, i.e., through a body of the article. When the treated surface provides moieties as a coating, the coating has any thickness envisioned. In an embodiment, the coating has a thickness of at least 3 nanometers (nm), such as at least 5 nm, such as at least 10 nm, or even greater than 20 nm. In an embodiment, the coating has a thickness of not greater than 1 micrometer (μm). When present through a thickness of the body, the moieties are present through a thickness from the surface of up to about 100 nanometers. It will be appreciated that the thickness of the coating or thickness through the body of the moieties can be within a range between any of the minimum and maximum values noted above.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

Although illustrated as a single layer tube, any number of layers is envisioned. For instance, the tube includes one layer, two layers, three layers, or even a greater number of layers. Typically, the layer has a thickness of at least about 0.002 inches to about 0.060 inches. It will be appreciated that the thickness of the layer can be within a range between any of the minimum and maximum values noted above. Irrespective of the number of layers present, the outside diameter and inner diameter of the tube can have any values as defined for the single layer tube 100 defined in FIG. 1. The number of layers is dependent upon the final properties desired for the tube.

In an embodiment, the article may be formed by any reasonable means, such as extrusion or injection molding. In a particular embodiment, the article is formed via extrusion. Any reasonable extrusion system is envisioned. The extrusion system typically includes a pumping system and can include a number of devices that can be utilized to form at least one layer of the article. For example, the pumping system can include a pumping device such as a gear pump, a static mixer, an extruder, a die, a radiation cure device, a post-processing device, or any combination thereof. In an embodiment, the silicone elastomer may be melt processed by dry blending or compounding. In an embodiment, the dry blend may be in powder, granular, or pellet form. In a particular embodiment, to form the article, pellets of the corresponding monomer or polymer may be compounded through a co-rotating intermeshing twin-screw extruder, cooled by a water bath, and cut into compound pellets. The article may be made by a continuous compounding process or batch related process. The resulting pellets of the blend are fed into an extruder with a die. The article is extruded through the die.

When the article includes multiple layers, each of the individual layers of the article may be formed by any reasonable means and is dependent upon the material and the configured location of each of the individual layers.

In an embodiment, the silicone elastomer, the thermoplastic elastomer, or combination thereof may be formed into a single layer article, a multi-layer article, or can be laminated, coated, or formed on a substrate. Multi-layer articles may include layers such as a polymeric layer, a reinforcing layer, an adhesive layer, a barrier layer, a chemically resistant layer, a metal layer, any combination thereof, and the like. Any reasonable method of providing any additional layer is envisioned and is dependent upon the material chosen. For instance, the additional layer may be an additional polymeric layer of a thermoplastic elastomer that may or may not be extruded. In an embodiment, any number of polymeric layers is envisioned. Any number of layers is also envisioned. The polymer can be formed into any useful shape such as film, sheet, tubing, and the like. The polymer may adhere or bond to other substrates including thermoplastic elastomers.

In an embodiment, the treated surface of the article has advantageous surface properties. For instance, the treated surface has a tack decrease of at least 50%, such as at least 60%, such as at least 70%, or even at least 75% compared to a non-treated surface. “Non-treated surface” as used herein refers to an identical material as the polymer chosen for the article, the identical material having a surface without any surface treatment. In an embodiment, the treated surface has a desirable tack. For instance, the treated surface of the article has a tack energy of less than 100 mN·mm, such as less than 75 mN·mm, such as less than 50 mN·mm, such as less than 25 mN·mm, such as less than 10 mN·mm. In an embodiment, there is no visible change on the surface to the naked eye.

Other advantageous properties of the treated surface include a reduced dust pick-up and desirable surface energy. For instance, the treated surface has a dust pick-up decrease of at least 20%, such as at least 30%, such as at least 40%, such as at least 50%, such as at least 60%, such as at least 70%, such as at least 80%, such as at least 85%, or even at least 95% compared to a non-treated surface. In an embodiment, the treated surface of the article has a surface energy of greater than 20 mN/m, such as greater than 25 mN/m, or even greater than 30 mN/m.

In an embodiment, the treated surface of the article has additional advantageous properties. In a particular embodiment, the treated surface has an advantageous coefficient of friction. For instance, the treated surface has a coefficient of friction (COF) that decreases by greater than about 30%, such as greater than about 40%, such as greater than about 50%, or even greater than about 60% compared to an untreated surface. In an embodiment, the treated surface has a coefficient of friction of 0.2 to 0.6, such as less than 0.6, such as even less than 0.5, or about 0.3, as measured by a Tribometer. It will be appreciated that the coefficient of friction can be within a range between any of the minimum and maximum values noted above.

Other properties of the treated surface desired are water contact angle and surface energy. For instance, the treated surface has a water contact angle of less than 100 degrees, such as less than 95 degrees, such as less than 90 degrees, such as less than 85 degrees, or even less than 80 degrees. Further, the surface energy of the article may be at least 30 mN/m. In comparison, the surface energy of an untreated silicone surface is about 18 mN/m.

In an embodiment, the resulting article may have further desirable physical and mechanical properties. For instance, the article is flexible and kink-resistant. Clarity of the article is checked visually and classified into four levels in terms of transparency: clear, translucent, hazy, and opaque. In particular, the resulting articles have desirable flexibility. For instance, the silicone elastomer, the thermoplastic elastomer, or combination thereof may advantageously produce low durometer articles. For example, an article having a Shore A durometer of between about 20 and about 90, such as between about 35 to about 75 as measured by ASTM D2240 having desirable mechanical properties may be formed. Such properties are indicative of a flexible material.

In exemplary embodiments, the article can be used in a variety of applications. Applications for the article are numerous. In particular, the non-toxic nature of the polymer, such as the silicone elastomer makes the article useful for any application where toxicity is undesired. For instance, the article has potential for FDA, ADCF, USP Class VI, NSF, European Pharmacopoeia compliant, United States Pharmacopoeia (USP) compliant, USP physiochemical compliant, ISO 10993 Standard for evaluating biocompatibility of a medical device, and other regulatory approvals. In a particular embodiment, the article may be non-cytotoxic, non-hemolytic, non-pyrogenic, animal-derived component-free, non-mutagenic, non-bacteriostatic, non-fungistatic, or any combination thereof.

In an embodiment, the article may be used in applications such as industrial, medical applications, health care, biopharmaceutical, drinking water, food & beverage applications, dairy applications, laboratory applications, FDA applications, laboratory applications, and the like. In an exemplary embodiment, the article includes a tube, a connector, a molded part, a septum, an infusion sleeve, a pump diaphragm, or a valve.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. An article includes at least one polymer, the at least one polymer including a silicone elastomer, a thermoplastic elastomer, or combination thereof, wherein the article has a treated surface to provide at least silicon moieties, silicon-oxide moieties, silica-like moieties, organosilicon moieties, hydroxyl moieties, hydrocarbon moieties, or combination thereof, wherein the treated surface has a tack decrease of at least 50% compared to a non-treated outer surface.

Embodiment 2. A method of treating an article including: providing an article including at least one polymer, the at least one polymer including a silicone elastomer, a thermoplastic elastomer, or combination thereof; and surface treating a surface of the at least one polymer to add at least silicon moieties, silicon-oxide moieties, silica-like moieties, organosilicon moieties, hydroxyl moieties, hydrocarbon moieties, or combination thereof, to the surface, wherein the treated surface has a tack decrease of at least 50% compared to a non-treated surface.

Embodiment 3. The article or the method of treating the article in accordance with any of the preceding embodiments, wherein the treated surface of the article has a tack energy of less than 100 mN·mm, such as less than 75 mN·mm, such as less than 50 mN·mm, such as less than 25 mN·mm, such as less than 10 mN·mm.

Embodiment 4. The article or the method of treating the article in accordance with any of the preceding embodiments, wherein the treated surface of the article has a surface energy of greater than 20 mN/m, such as greater than 25 mN/m, or even greater than 30 mN/m.

Embodiment 5. The article or the method of treating the article in accordance with any of the preceding embodiments, wherein the silicone elastomer includes a polyorganosiloxane.

Embodiment 6. The article or the method of treating the article in accordance with embodiment 5, wherein the polyorganosiloxane includes a hydride-containing polyalkylsiloxane, a vinyl-containing polyalkylsiloxane, or combination thereof.

Embodiment 7. The article or method of treating the article in accordance with any of the preceding embodiments, wherein the treated surface has a dust pick-up decrease of at least 20% compared to a non-treated surface.

Embodiment 8. The article or the method of treating the article in accordance with any of the preceding embodiments, wherein the silicon moieties, silicon-oxide moieties, silica-like moieties, organosilicon moieties, hydroxyl moieties, hydrocarbon moieties, or combination thereof are present as a coating.

Embodiment 9. The article or the method of treating the article in accordance with embodiment 8, wherein the coating has a thickness of at least 3 nanometers (nm), such as at least 5 nm, such as at least 10 nm, or even greater than 20 nm.

Embodiment 10. The article or the method of treating the article in accordance with embodiment 9, wherein the coating has a thickness of not greater than 1 micrometer (μm).

Embodiment 11. The article or the method of treating the article in accordance with embodiments 1-7, wherein the silicon moieties, silicon-oxide moieties, silica-like moieties, organosilicon moieties, hydroxyl moieties, hydrocarbon moieties, or combination thereof are present from the surface through a thickness of the article.

Embodiment 12. The article or the method of treating the article in accordance with any of the preceding embodiments, wherein the article has a shore A durometer of about 20 to about 90, as measured by ASTM D2240.

Embodiment 13. The article or the method of treating the article in accordance with any of the preceding embodiments, wherein the treated surface has a water contact angle of less than 100 degrees, such as less than 95 degrees, such as less than 90 degrees, such as less than 85 degrees, or even less than 80 degrees.

Embodiment 14. The article or the method of treating the article in accordance with any of the preceding embodiments, wherein the treated surface has a coefficient of friction (COF) that decreases by greater than about 30%, such as greater than about 40%, such as greater than about 50%, or even greater than about 60% compared to an untreated surface.

Embodiment 15. The article or the method of treating the article in accordance with any of the preceding embodiments, wherein the treated surface has a coefficient of friction of 0.2 to 0.6, such as less than 0.6, or even less than 0.5.

Embodiment 16. The article or the method of treating the article in accordance with any of the preceding embodiments, wherein the treated surface has a surface energy of at least 30 mN/m.

Embodiment 17. The article or the method of treating the article in accordance with any of the preceding embodiments, wherein the article includes a tube having an inner surface that defines a central lumen of the tube.

Embodiment 18. The article or the method of treating the article in accordance with embodiment 17, wherein the tube has an inner diameter of about 0.005 inches to about 4.00 inches.

Embodiment 19. The article or the method of treating the article in accordance with embodiment 17, having an outer diameter of about 0.25 inches to about 5.00 inches.

Embodiment 20. The article of method of treating the article in accordance with embodiments 1-16, wherein the article includes a connector, a molded part, a septum, an infusion sleeve, a pump diaphragm, or a valve.

Embodiment 21. The article or the method of treating the article in accordance with any of the preceding embodiments, wherein the article is a medical article, a pharmaceutical article, a biopharmaceutical article, a laboratory article, or a food and beverage article.

Embodiment 22. The method of treating the article in accordance with embodiments 2-21, wherein the surface treatment includes plasma enhanced chemical vapor deposition, flame treatment, plasma activation, chemical vapor deposition, or combination thereof.

Embodiment 23. The method of treating the article in accordance with embodiment 22, wherein the surface treatment includes plasma enhanced chemical vapor deposition in the presence of a silane compound, a siloxane compound, or combination thereof comprising an alkoxysilane, cyclic silane, or combination thereof.

Embodiment 24. The method of treating the article in accordance with embodiment 23, wherein the siloxane compound includes tetramethylcyclotetrasiloxane (TMCTS), hexamethyldisiloxane (HMDSO), tetraethyl orthosilicate (TEOS), octamethylcyclotetrasiloxane (OMCTS), or combination thereof.

Embodiment 25. The method of treating the article in accordance with embodiment 22, wherein the surface treatment includes flame treatment in the presence of methane, propane, butane, coal gas, or combination thereof.

Embodiment 26. The method of treating the article in accordance with embodiment 25, wherein the flame treat is at a time of 0.5 seconds to 30 seconds.

Embodiment 27. A method of treating an article including: providing an article including at least one polymer, the at least one polymer including a silicone elastomer; and surface treating a surface of the at least one polymer to reduce the tack of the treated surface, wherein the surface treatment includes plasma enhanced chemical vapor deposition, flame treatment, or combination thereof.

Embodiment 28. The method of treating the article in accordance with embodiment 27, wherein the surface treatment includes plasma enhanced chemical vapor deposition in the presence of a siloxane compound, a silane compound, or combination thereof comprising an alkoxysilane, cyclic silane, or combination thereof.

Embodiment 29. The method of treating the article in accordance with embodiment 28, wherein the siloxane compound includes tetramethylcyclotetrasiloxane (TMCTS), hexamethyldisiloxane (HMDSO), tetraethyl orthosilicate (TEOS), octamethylcyclotetrasiloxane (OMCTS), or combination thereof.

Embodiment 30. The method of treating the article in accordance with embodiment 27, wherein the surface treatment includes flame treatment in the presence of methane, propane, butane, coal gas, or combination thereof.

Embodiment 31. The method of treating the article in accordance with embodiment 30, wherein the flame treat is at a time of 0.5 seconds to 30 seconds.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### Examples

For example, in one embodiment, a hydride-containing polyalkylsiloxane was treated using an oxygen plasma discharge in the presence of hexamethyldisiloxane. The gas pressure, the power and the treatment duration were adjusted and optimized to reach the desired tack energy. For instance, using a pressure of 0.5 mbar for 20 minutes at a power of at least 70 W led to a surface with a tack energy of 0.03 N·mm or less.

In another embodiment, a vinyl-containing polyalkylsiloxane is treated using an atmospheric pressure argon plasma discharge with or without the presence of oxygen and/or nitrogen and in the presence of tetramethylcyclotetrasiloxane, at a line speed of 5 mm/s with at least one treatment pass, to reach a lightness value after carbon black spraying of 95% of the clean treated substrate, compared to 75% for the untreated polyalkylsiloxane substrate, which corresponds to a dust pick up reduction of 20%.

In another embodiment, a vinyl-containing polyalkylsiloxane was exposed to an argon plasma discharge in the presence of tetramethylcyclotetrasiloxane with or without the presence of oxygen at a pressure of 0.2 mbar for 5 minutes at a power of 50 W and led to a surface with a coefficient of friction at least half the value of the untreated surface.

For example, in one embodiment, the untreated substrate surface was partially oxidized or burned during the flame treatment process and led to a glass-like layer coating on the treated substrate. The gas was pure flammable gas such as methane, propane, etc. The temperature (such as between 990° C. to 1200° C.), the flame strength, the flame displacement (0.5 inches to 2.0 inches), treatment duration time and product moving speed was adjusted individually or combined to provide moieties as described. The treated flame system was evaluated and optimized by contact angle, surface energy and treated surface tackiness tests. After treatment, the substrate contact angle was reduced to 64° from 107°; surface energy was increased to 44 mN/m from 22 mN/m; the tackiness energy was reduced to 0.005 N·mm or less from 0.15 N·mm; the dust pick-up test was reduced of 20%, with a lightness after carbon black spraying of at least 95% of the clean treated substrate, compared to 75% for the untreated substrate.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An article comprising at least one polymer, the at least one polymer comprising a silicone elastomer, a thermoplastic elastomer, or combination thereof, wherein the article has a treated surface providing at least silicon moieties, silicon-oxide moieties, silica-like moieties, organosilicon moieties, hydroxyl moieties, hydrocarbon moieties, or combination thereof to the treated surface, wherein the treated surface has a tack decrease of at least 50% compared to a non-treated surface.

2. The article in accordance with claim 1, wherein the treated surface of the article has a tack energy of less than 100 mN·mm, such as less than 75 mN·mm, such as less than 50 mN·mm, such as less than 25 mN·mm, such as less than 10 mN·mm.

3. The article in accordance with claim 1, wherein the treated surface of the article has a surface energy of greater than 20 mN/m, such as greater than 25 mN/m, or even greater than 30 mN/m.

4. The article in accordance with claim 1, wherein the silicone elastomer comprises a polyorganosiloxane.

5. The article in accordance with claim 4, wherein the polyorganosiloxane comprises a hydride-containing polyalkylsiloxane, a vinyl-containing polyalkylsiloxane, or combination thereof.

6. The article in accordance with claim 1, wherein the treated surface has a dust pick-up decrease of at least 20% compared to a non-treated surface.

7. The article in accordance with claim 1, wherein the silicon moieties, silicon-oxide moieties, silica-like moieties, organosilicon moieties, hydroxyl moieties, hydrocarbon moieties or combination thereof are present as a coating.

8. The article in accordance with claim 1, wherein the silicon moieties, silicon-oxide moieties, silica-like moieties, organosilicon moieties, hydroxyl moieties, hydrocarbon moieties, or combination thereof are present from the surface through a thickness of the article.

9. The article in accordance with claim 1, wherein the treated surface has a water contact angle of less than 100 degrees, such as less than 95 degrees, such as less than 90 degrees, such as less than 85 degrees, or even less than 80 degrees.

10. The article in accordance with claim 1, wherein the treated surface has a coefficient of friction (COF) that decreases by greater than about 30%, such as greater than about 40%, such as greater than about 50%, or even greater than about 60% compared to an untreated article.

11. The article in accordance with claim 1, wherein the treated surface has a coefficient of friction of 0.2 to 0.6 such as less than 0.6, or even less than 0.5.

12. The article in accordance with claim 1, wherein the treated surface has a surface energy of at least 30 mN/m.

13. The article in accordance with claim 1, wherein the article comprises a tube having an inner surface that defines a central lumen of the tube.

14. The article in accordance with claim 1, wherein the article comprises a connector, a molded part, a septum, an infusion sleeve, a pump diaphragm, or a valve.

15. A method of treating an article comprising:
providing an article comprising at least one polymer, the at least one polymer comprising a silicone elastomer, a thermoplastic elastomer, or combination thereof; and
surface treating a surface of the at least one polymer to add at least silicon moieties, silicon-oxide moieties, silica-like moieties, organosilicon moieties, hydroxyl moieties, hydrocarbon moieties, or combination thereof, to the surface, wherein the treated surface has a tack decrease of at least 50% compared to a non-treated surface.

16. The method of treating the article in accordance with claim 15, wherein the surface treatment comprises plasma enhanced chemical vapor deposition, flame treatment, plasma activation, chemical vapor deposition, or combination thereof.

17. The method of treating the article in accordance with claim 16, wherein the surface treatment comprises plasma enhanced chemical vapor deposition in the presence of a siloxane compound, a silane compound, or combination thereof comprising an alkoxysilane, cyclic silane, or combination thereof.

18. The method of treating the article in accordance with claim 17, wherein the silane compound comprises tetramethylcyclotetrasiloxane (TMCTS), hexamethyldisiloxane (HMDSO), tetraethyl orthosilicate (TEOS), octamethylcyclotetrasiloxane (OMCTS), or combination thereof.

19. The method of treating the article in accordance with claim 16, wherein the surface treatment comprises flame treatment in the presence of methane, propane, butane, coal gas, or combination thereof.

20. A method of treating an article comprising:
providing an article comprising at least one polymer, the at least one polymer comprising a silicone elastomer; and
surface treating a surface of the at least one polymer to reduce the tack of the surface, wherein the surface treatment comprises plasma enhanced chemical vapor deposition, flame treatment, or combination thereof.
